(19) United States
(12) Patent Application Publication
(10) Pub. No.: US 2020/0128489 A1
(43) Pub. Date: Apr. 23, 2020

(54) DETERMINE TRANSMIT POWER

(71) Applicant: Hewlett Packard Enterprise Development LP, Houston, TX (US)

(72) Inventors: Andre BEAUDIN, Montreal (CA); Shahnawaz SIRAJ, San Jose, CA (US); Qiang ZHOU, Beijing (CN); Jianpo HAN, Beijing (CN)

(21) Appl. No.: 16/653,242

(22) Filed: Oct. 15, 2019

(30) Foreign Application Priority Data
Oct. 19, 2018 (CN) 201811221424.5

(51) Int. Cl. H04W 52/24; H04W 52/36

(52) U.S. Cl. CPC H04W 52/245; H04W 52/241; H04W 52/36

(57) ABSTRACT

The present invention relates to determining transmit power. An example method may include assigning, by a processor of a network device, resource units (RUs) for a plurality of client devices, respectively; monitoring, by the processor, signal quality between the network device and each of the plurality of client devices; and determining, by the processor, transmit power of each RU based on the monitored signal quality between the network device and the client device that the RU corresponds to.

### BACKGROUND

In a wireless system, devices may wirelessly communicate with each other, and transmit power may be assigned for the wireless communication between the devices.

### BRIEF DESCRIPTION OF THE DRAWINGS

FIG. 1 is a block diagram illustrating an example wireless system according to present disclosure;

FIG. 2 is a flow chart illustrating an example method of determining transmit power according to present disclosure;

FIG. 3 is a flow chart illustrating another example method of determining transmit power according to present disclosure;

FIG. 4 is a flow chart illustrating another example method of determining transmit power according to present disclosure;

FIG. 5 is a flow chart illustrating another example method of determining transmit power according to present disclosure;

FIG. 6 is a flow chart illustrating another example method of determining transmit power according to present disclosure;

FIG. 7 is schematic representation of a computer readable medium, according to an example of the present disclosure.

### DETAILED DESCRIPTION

In a wireless system, such as the system utilizing orthogonal frequency division multiple access (OFDMA), a network device, e.g. an access point (AP) may wirelessly communicate with a plurality of other devices, e.g. client devices.

In some cases, e.g. in IEEE 802.11ax standard, the AP may communicate with multiple client devices simultaneously by assigning subsets of subcarriers, e.g. resource units (RUs) to the multiple client devices, and the same transmit power is applied for each RU.

The multiple client devices may distribute at different locations, and network transmission performance is influenced when the same transmit power is applied for each RU. For example, if relatively high transmit power is applied for each RU, transmission cost is wasted, while if relatively low transmit power is applied for each RU, more tries or high packet error rate may be occurs for some of the client devices.

In order to improve network transmission performance, the AP may consider different conditions of each client device, and provide a specific transmit power for the RU corresponding to the client device, so as to avoid provide the same transmit power for the RUs located at different locations, and the overall network transmission quality is improved while the transmission cost is saved as much as possible.

In one example, a method comprising: assigning, by a processor of a network device, resource units (RUs) for a plurality of client devices, respectively; monitoring, by the processor, signal quality between the network device and each of the plurality of client devices; and determining, by the processor, transmit power of each RU based on the monitored signal quality between the network device and the client device that the RU corresponds to.

In another example, a network device, comprising at least: a memory; a processor executing instructions from the memory to: assign resource units (RUs) for a plurality of client devices respectively; monitoring, by the processor, signal quality between the network device and each of the plurality of client devices; and determine transmit power of each RU based on the monitored signal quality between the network device and the client device that the RU corresponds to.

In another example, a non-transitory machine-readable storage medium encoded with instructions executable by at least one hardware processor of a network device, the machine-readable storage medium comprising instructions to: assign resource units (RUs) for a plurality of client devices respectively; monitoring, by the processor, signal quality between the network device and each of the plurality of client devices; and determining, by the processor, transmit power of each RU based on the monitored signal quality between the network device and the client device that the RU corresponds to.

As used herein, a “network device” generally includes a device that is adapted to transmit and/or receive signaling and to process information within such signaling and to provide wireless local area network services to a station (e.g., any data processing equipment such as a computer, cellular phone, personal digital assistant, tablet devices, etc.). The “network device” may include access points, data transfer devices, network switches, routers, controllers, etc. As used herein, an “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

It is appreciated that examples described herein below may include various components and features. Some of the components and features may be removed and/or modified without departing from a scope of the device, method and non-transitory computer readable storage medium for. It is also appreciated that, in the following description, numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example. As used herein, a component is a combination of hardware and software executing on that hardware to provide a given functionality.

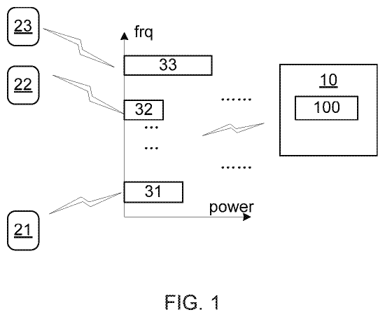

FIG. 1 is a block diagram illustrating an example wireless system according to present disclosure. Referring to FIG. 1, a wireless system, e.g. wireless local area networks (WLAN), includes a network device 10, such as an AP, a plurality of client devices 21, 22 and 23.

One of the client devices 21, 22 and 23 may be a smartphone, a mobile phone, a Personal Digital Assistant (PDA), a portable personal computer, an AIO (all-in-one) computing device, a notebook, a convertible or hybrid notebook, a netbook, a tablet, a cellular device, a desktop computer, a multimedia player, an entertainment unit, a data communication device, a portable reading device, or any other computing device capable of transmitting and receiving wireless transmissions and consuming a wireless service. Wireless service may include, for example, WLAN access, guest authentication, printing, projector, locationing, indoor wayfinding, asset tracking, security/threat monitoring and/or detection, user behavior modeling, loT (internee of things) connectivity, wireless user data analytics, edge data analytics, edge security, edge data collection, etc.

The network device 10 may include a processor 100. The processor 100 may assign RU 31 for client device 21, assign RU 32 for client device 22 and assign RU 33 for client device 23.

For example, initial transmit power assigned for each of RU 31, RU 32 and RU 33 may be the same default value.

The network device 10 may monitor signal quality between the network device 10 and each of the client devices 21, 22 and 23.

The network device 10 may determine the transmit power of RU 31 based on the monitored signal quality between the network device 10 and the client device 21, determine the transmit power of RU 32 based on the monitored signal quality between the network device 10 and the client device 22, and determine the transmit power of RU 33 based on the monitored signal quality between the network device 10 and the client device 23.

In an example, based on different signal quality between the network device 10 and each of the client devices 21, 22 and 23, the transmit powers determined for RU1, RU2 and RU3 may be determined accordingly, and become different from each other.

For example, the signal quality between the network device 10 and the client device 22 is relatively high, the network device 10 may determine to lower the transmit power of RU 32, and thus RU 32 has the lowest transmit power among RU 31, RU 32 and RU 33 as shown in FIG. 1; the signal quality between the network device 10 and the client device 23 is relatively low, the network device 10 may determine to increase the transmit power of RU 33, and thus RU 33 has the highest transmit power among RU 31, RU 32 and RU 33 as shown in FIG. 1.

In this way, the optimal transmit power configuration is determined for different RUs. For example, compared with the existing transmit power control in which client devices at different locations are assigned with the same transmit power, the client device far away from the network device may correspond to more transmit power and the client device close to the network device may correspond to less transmit power. Accordingly, transmission rate and transmission range for the client device are optimized, and co-channel interference between client devices close to the network device is decreased.

In another example, at least one of the RU 31, RU 32 and RU 33 may correspond to a moving client device. In this case, the signal quality between the network device 10 and each of the moving client devices may be changed due to the moving of the client device. The network device 10 may monitor the signal quality and determine the transmit power of the RU corresponding to the moving client device periodically.

For example, when the client device 23 is a client device moving away from the network device 10, and the signal quality between the network device 10 and the client device 23 is gradually reduced. The network device 10 may monitor the signal quality between the network device 10 and the client device 23. When the reduced signal quality reaches a preconfigured threshold, the network device 10 may determine to increase the transmit power of RU 33 corresponding to the client device 23.

Hence, the optimal transmit power is dynamically determined for the RU corresponding to the moving client device.

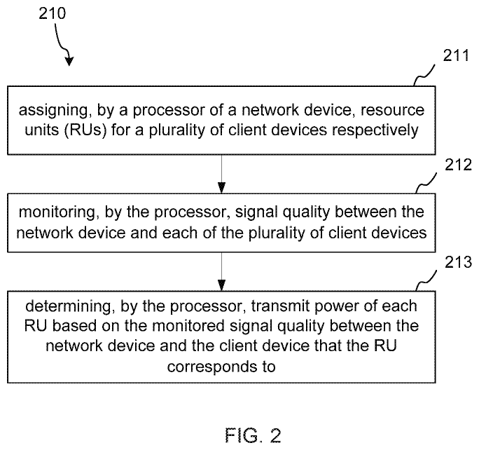

FIG. 2 is a flow chart illustrating an example method of determining transmit power according to present disclosure. Referring to FIG. 2:

The method 210 comprising: assigning, by a processor of a network device, resource units (RUs) for a plurality of client devices respectively, at 211.

For example, each RU may be assigned to a client device randomly, and the initial transmit power assigned for each RU may be the same default value. Other manners for assigning the RUs may be used, which is not limited in the examples of the present invention.

The method 210 comprising: monitoring, by the processor, signal quality between the network device and each of the plurality of client devices, at 212.

In an example, after the RU is assigned for the client device, the network device may communicate with the client device, and monitor the signal quality between the network device and this client device.

For example, the processor of the network device may directly monitor certain information (e.g. signal strength indicator (RSSI) in the packet) in the packet that indicates the signal quality. For another example, the processor of the network device may monitor information in the packet that related to the signal quality, and then determine the signal quality (e.g. packet error rate) based on the monitored information.

In an example, the signal quality may include at least one of the receive signal strength indicator (RSSI) and a distance between the network device and the client device. In an example, the signal quality may further include at least one of packet error rate and data rate between the network device and the client device.

The method 210 also comprising: determining, by the processor, transmit power of each RU based on the monitored signal quality between the network device and the client device that the RU corresponds to, at 213.

In an example, the network device may store a relationship between the signal quality between the network device and the client device and the transmit power to be determined for the corresponding RU. For example, a data table recording the relationship may be stored in a computer readable storage medium of the network device. According to an example, in the relationship, a certain range of the signal quality may correspond to a certain transmit power. The processor may determine the range to which the monitored signal quality belongs, and then determine the transmit power corresponding to the range as the transmit power of the RU.

In another example, the network device may preconfigure a signal quality first threshold and a signal quality second threshold. If the monitored signal quality is higher than the signal quality first threshold, the network device may reduce the transmit power the RU for a predetermined first increment. If the monitored signal quality is lower than the signal quality second threshold, the network device may increase the transmit power the RU for a predetermined second increment. The predetermined first increment may be different from or the same with the predetermined second increment.

Other manners for determining the transmit power of the RU based on the monitored signal quality may be used, which is not limited in the examples of the present invention.

In this way, the network device may determine the transmit power for each RU separately, and the transmit power determined for different RUs may be different from each other, thereby avoiding the problems caused by the same transmit power applied for each RU.

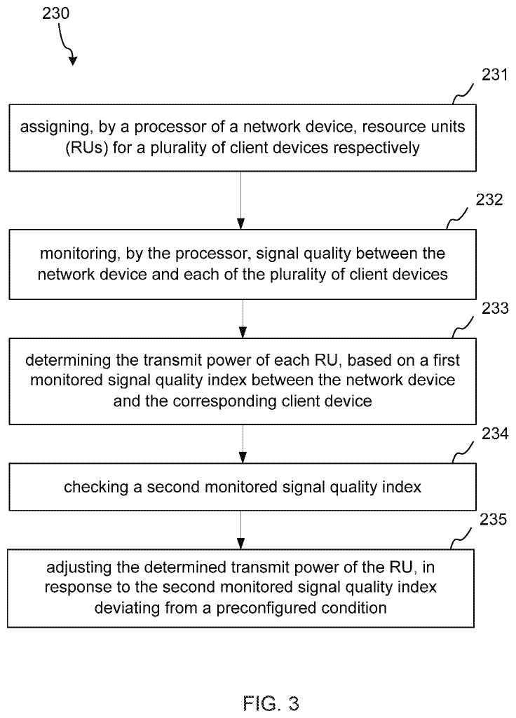

Now referring to FIG. 3. FIG. 3 is a flow chart illustrating another example method 230 of determining transmit power according to present disclosure.

As shown in FIG. 3, at step 231, a processor of a network device may assign RUs for a plurality of client devices respectively. The initial transmit power assigned for each RU may be the same default value.

At step 232, the processor of the network device may monitor signal quality between the network device and each of the plurality of client devices. This step is similar to step 212

At step 233, the processor of the network device may determine the transmit power of each RU based on a first monitored signal quality index between the network device and the corresponding client device.

In an example, the first monitored signal quality index includes at least one of receive signal strength indicator (RSSI) and a distance between the network device and the client device.

For example, the first monitored signal quality index is the RSSI between the network device and the client device. For a certain client device, if the monitored RSSI between the network device and the client device is higher than a preset RSSI first threshold, the network device may reduce the transmit power of the RU corresponding to the client device for a first predetermined increment. If the monitored RSSI between the network device and the client device is lower than a preset RSSI second threshold, the network device may increase the transmit power of the RU corresponding to the client device for a second predetermined increment.

For another example, the first monitored signal quality index is distance between the network device and the client device. For a certain client device, if the monitored distance between the network device and the client device is longer than a preset distance first threshold, the network device may increase the transmit power of the RU corresponding to the client device for the second predetermined increment. If the monitored distance between the network device and the client device is shorter than a preset distance second threshold, the network device may reduce the transmit power of the RU corresponding to the client device for the first predetermined increment.

In an example, the first predetermined increment may be different from or the same with the second predetermined increment.

At step 234, the processor of the network device may check a second monitored signal quality index.

In an example, the second monitored signal quality index includes at least one of packet error rate and data rate between the network device and the client device.

After the transmit power of the RU is changed at step 233, the signal quality between the network device and the corresponding client device may be changed accordingly. In an example, the changed signal quality is monitored to ensure that the changed signal quality is within an acceptable scope. If the changed signal quality is not acceptable, the following steps may be performed.

At step 235, the processor of the network device may adjust the transmit power of the RU determined at step 233, in response to the second monitored signal quality index deviating from a preconfigured condition.

For example, the preconfigured condition may include at least one of that the packet error rate between the network device and the client device is less than a preconfigured packet error rate threshold and the data rate between the network device and the client device is more than a preconfigured data rate threshold.

For example, after reducing the transmit power of the RU at step 233, the processor of the network device may check at least one of the packet error rate and the data rate between the network device and the client device, and adjust the determined transmit power of the RU accordingly.

In an example, for a certain client device, if the packet error rate between the network device and the client device is more than the preconfigured packet error rate threshold or if the data rate between the network device and the client device is less than the preconfigured data rate threshold, the network device may adjust the determined transmit power of the RU. For example, the transmit power of the RU may be increased for a certain increment.

In an example, if the changed signal quality is acceptable, e.g. for a certain client device, if the packet error rate between the network device and the client device is less than or equal to the preconfigured packet error rate threshold and the data rate between the network device and the client device is more than or equal to the preconfigured data rate threshold, the transmit power determined at step 233 may be kept unchanged.

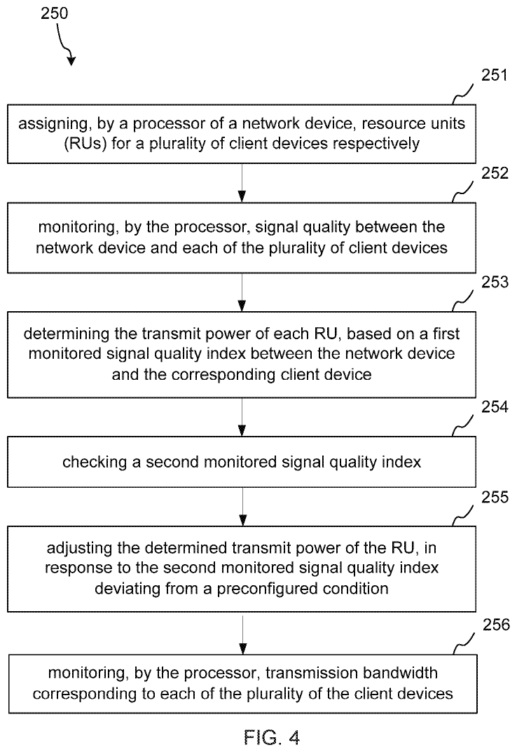

FIG. 4 is a flow chart illustrating another example method 250 of transmitting multicast frame according to present disclosure. In the example shown in FIG. 4, step 251 to step 255 are similar to step 231 to 235 shown in FIG. 3.

As shown in FIG. 4, the method 250 further includes the step 256 in which transmission bandwidth corresponding to each of the plurality of the client devices may be monitored by the processor of the network device.

In an example, during increasing the transmit power of the RU corresponding to the client device, the processor of the network device may monitor transmission bandwidth corresponding to the client device. If the transmission bandwidth corresponding to the client device is larger than a preset transmission bandwidth threshold, the increased transmit power of the RU is limited to be less than or equal to a largest allowable transmit power corresponding to the transmission bandwidth, so as to avoid strong interference caused by the RU.

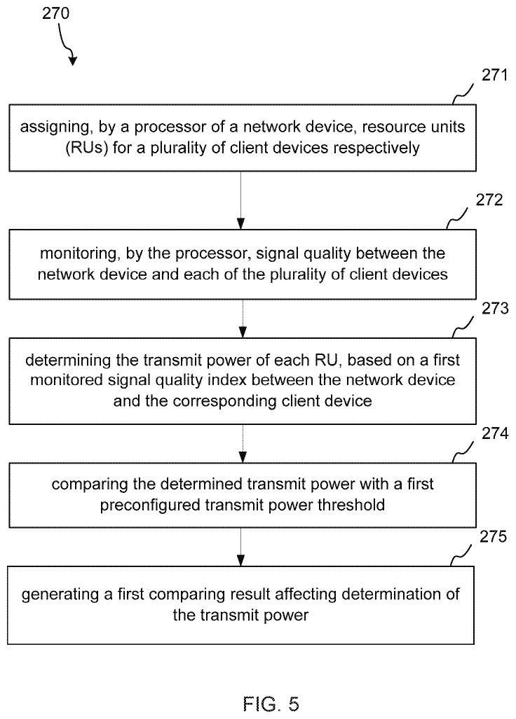

FIG. 5 is a flow chart illustrating another example method 270 of transmitting multicast frame according to present disclosure. In the example shown in FIG. 5, step 271 to step 273 are similar to step 231 to 233 shown in FIG. 3.

As shown in FIG. 5, the method 270 further includes the step 274 in which the determined transmit power may be compared with a first preconfigured transmit power threshold.

In an example, after determining the transmit power of the RU corresponding to the client device, the processor of the network device may compare the determined transmit power with the first preconfigured transmit power threshold.

In an example, the first preconfigured transmit power threshold may be a maximum transmit power allowed for each RU by regulation.

The method 270 further includes the step 275 in which a first comparing result affecting determination of the transmit power may be generated.

For example, the first comparing result may be that the determined transmit power is less than or equal to the first preconfigured transmit power threshold, then the determined transmit power is kept unchanged.

For another example, the first comparing result may be that the determined transmit power is larger the first preconfigured transmit power threshold, then the determined transmit power is adjust to be less than or equal to the first preconfigured transmit power threshold. For example, the transmit power may be adjusted to be equal to the first preconfigured transmit power threshold, e.g. the maximum transmit power allowed for each RU by regulation.

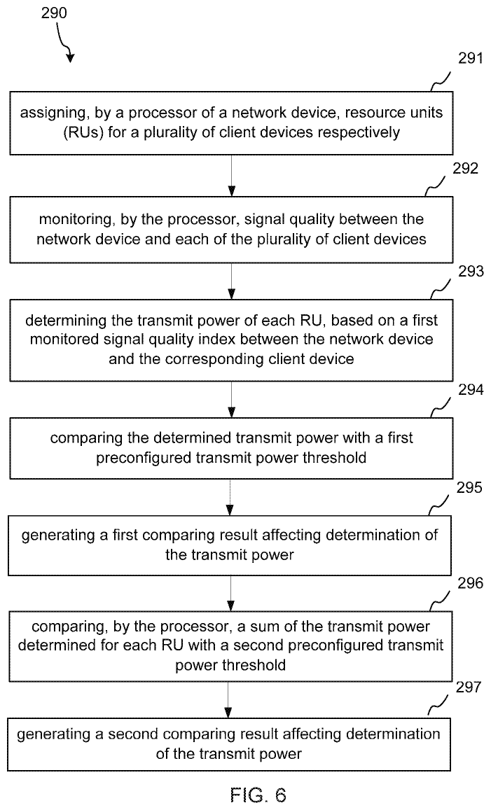

FIG. 6 is a flow chart illustrating another example method 290 of transmitting multicast frame according to present disclosure. In the example shown in FIG. 5, step 291 to step 295 are similar to step 271 to 275 shown in FIG. 5.

As shown in FIG. 6, the method 290 further includes the step 296 in which a sum of the transmit power determined for each RU may be compared with a second preconfigured transmit power threshold,

For example, after determining the transmit power of each RU, the processor of the network device may obtain the sum of the transmit power determined for each RU and compare the obtained sum with the second preconfigured transmit power threshold.

In an example; the second preconfigured transmit power threshold may be a maximum transmit power allowed for all RU of the network device by regulation.

The method 290 further includes the step 297 in which a second comparing result affecting determination of the transmit power may be generated.

For example, the second comparing result may be that the obtained sum is less than or equal to the second preconfigured transmit power threshold, then the transmit power determined for each RU is kept unchanged.

For another example, the second comparing result may be that the obtained sum is larger the second preconfigured transmit power threshold, then the determined transmit powers are adjust to make the sum of the adjusted transmit power to be less than or equal to the second preconfigured transmit power threshold. For example, all of the transmit powers determined for the plurality RUs may be reduced by the same proportion, so that the sum of the reduced transmit powers of the plurality RUs is equal to the maximum transmit power allowed for all RU of the network device by regulation.

While illustrated in a particular order, the flowcharts described herein are not intended to be so limited. Rather, it is expressly contemplated that various processes may occur in different orders and/or simultaneously with other processes than those illustrated. Additional or fewer operations or combinations of operations may be used or may vary without departing from the scope of the disclosed examples. Thus, the present disclosure merely sets forth possible examples of implementations, and many variations and modifications may be made to the described examples.

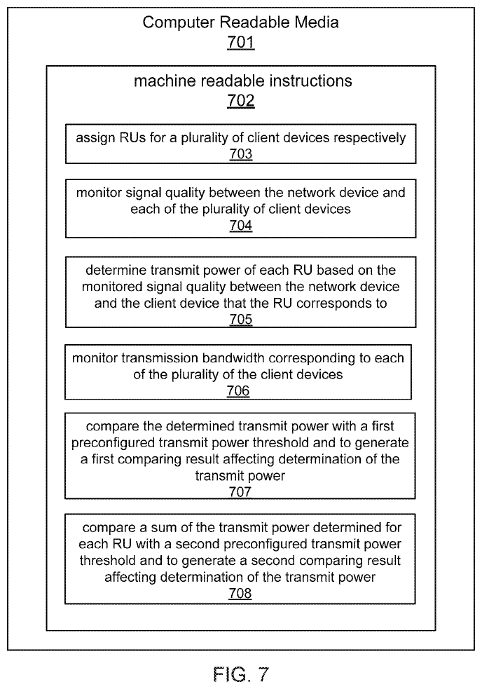

FIG. 7 is schematic representation of a computer readable medium, according to an example of the present disclosure. Turning now to FIG. 7, there is shown a schematic representation 700 of a computer readable medium 701, according to an example of the present disclosure. The computer readable medium 701 may be any suitable medium that participates in providing instructions to a processor (not shown) for execution. For example, the computer readable medium 701 may be non-volatile media, such as an optical or a magnetic disk; volatile media, such as memory. The computer-readable medium 701 may also store machine readable instructions 702, which, when executed may cause the processor to perform some or all of the methods 210, 230, 250, 270 and 290 depicted in FIGS. 2 to 6. In this regard, the machine readable instructions 702 may include instructions to assign RUs for a plurality of client devices respectively 703, instructions to monitor signal quality between the network device and each of the plurality of client devices 704, instructions to determine transmit power of each RU based on the monitored signal quality between the network device and the client device that the RU corresponds to 705. In an example, the signal quality may include at least one of the receive signal strength indicator (RSSI) and a distance between the network device and the client device. In an example, the signal quality may further include at least one of packet error rate and data rate between the network device and the client device.

In an example, determining transmit power of each RU based on the monitored signal quality between the network device and the client device that the RU corresponds to may include determining the transmit power of each RU based on a first monitored signal quality index between the network device and the corresponding client device, checking a second monitored signal quality index, and adjusting the determined transmit power of the RU in response to the second monitored signal quality index deviating from a preconfigured condition. In an example, the first monitored signal quality index includes at least one of receive signal strength indicator (RSSI) and a distance between the network device and the client device, the second monitored signal quality index includes at least one of packet error rate and data rate between the network device and the client device. In an example, adjusting the determined transmit power of the RU includes increasing the determined transmit power for a certain increment.

In an example, the machine readable instructions 702 may further include instructions to monitor transmission bandwidth corresponding to each of the plurality of the client devices 706. In an example, the monitored transmission bandwidth is used to limit the transmit power of the RU to be less than or equal to a largest allowable transmit power corresponding to the transmission bandwidth.

In an example, the machine readable instructions 702 may further include instructions to compare the determined transmit power with a first preconfigured transmit power threshold and to generate a first comparing result affecting determination of the transmit power 707. In an example, the first preconfigured transmit power threshold may be a maximum transmit power allowed for each RU by regulatory. In the example, the first comparing result may include the determined transmit power is larger the first preconfigured transmit power threshold, and affecting the determination of the transmit power may include that the determined transmit power is adjust to be less than or equal to the first preconfigured transmit power threshold.

In an example, the machine readable instructions 702 may further include instructions to compare a sum of the transmit power determined for each RU with a second preconfigured transmit power threshold and to generate a second comparing result affecting determination of the transmit power 708. In an example, the second preconfigured transmit power threshold may be a maximum transmit power allowed for all RU by regulation. In the example, the second comparing result may include the obtained sum is larger the second preconfigured transmit power threshold, and affecting the determination of the transmit power may include that the determined transmit powers are adjust to make the sum of the adjusted transmit power to be less than or equal to the second preconfigured transmit power threshold.

While the present disclosure has been described in connection with certain example embodiments, it is to be understood that the disclosure is not limited to the disclosed embodiments, but, on the contrary, is intended to cover various modifications and equivalent arrangements included within the spirit and scope of the appended claims, and equivalents thereof.

What is claimed is:

1. A method comprising:
assigning, by a processor of a network device, resource units (RUs) for a plurality of client devices, respectively;
monitoring, by the processor, signal quality between the network device and each of the plurality of client devices; and
determining, by the processor, transmit power of each RU based on the monitored signal quality between the network device and the client device that the RU corresponds to.

2. The method of claim 1, wherein determining transmit power of each RU based on the monitored signal quality comprises:
determining the transmit power of each RU, based on a first monitored signal quality index between the network device and the corresponding client device;
checking a second monitored signal quality index; and
adjusting the determined transmit power of the RU, in response to the second monitored signal quality index deviating from a preconfigured condition.

3. The method of claim 2, wherein the first monitored signal quality index includes at least one of receive signal strength indicator (RSSI) and a distance between the network device and the client device.

4. The method of claim 2, wherein the second monitored signal quality index includes at least one of packet error rate and data rate between the network device and the client device.

5. The method of claim 1, further comprising:
monitoring, by the processor, transmission bandwidth corresponding to each of the plurality of the client devices.

6. The method of claim 1, further comprising:
comparing the determined transmit power with a first preconfigured transmit power threshold;
generating a first comparing result affecting determination of the transmit power.

7. The method of claim 1, further comprising:
comparing, by the processor, a sum of the transmit power determined for each RU with a second preconfigured transmit power threshold;
generating a second comparing result affecting determination of the transmit power.

8. The method of claim 1, wherein the network device comprises an Access Point (AP).

9. A network device, comprising at least:
a memory;
a processor executing instructions from the memory to:
assign resource units (RUs) for a plurality of client devices respectively;
monitor signal quality between the network device and each of the plurality of client devices; and
determine transmit power of each RU based on the monitored signal quality between the network device and the client device that the RU corresponds to.

10. The network device of claim 9, wherein the processor further executes the instructions from the memory to;
determining the transmit power of each RU, based on a first monitored signal quality index between the network device and the corresponding client device;
checking a second monitored signal quality index; and
adjusting the determined transmit power of the RU, in response to the second monitored signal quality index deviating from a preconfigured condition.

11. The method of claim 10, wherein the first monitored signal quality index includes at least one of receive signal strength indicator (RSSI) and a distance between the network device and the client device.

12. The method of claim 10; wherein the second monitored signal quality index includes at least one of packet error rate and data rate between the network device and the client device.

13. The network device of claim 9, wherein the processor further executes the instructions from the memory to:
monitor transmission bandwidth corresponding to each of the plurality of the client devices.

14. The network device of claim 9, wherein the processor further executes the instructions from the memory to:
compare the determined transmit power with a first preconfigured transmit power threshold;
generate a first comparing result affecting determination of the transmit power.

15. The network device of claim 9; wherein the processor further executes the instructions from the memory to:
comparing a sum of the transmit power determined for each RU with a second preconfigured transmit power threshold;
generating a second comparing result affecting determination of the transmit power.

16. The network device of claim 9, wherein the network device comprises an Access Point (AP).

17. A non-transitory machine-readable storage medium encoded with instructions executable by at least one hardware processor of a network device, the machine-readable storage medium comprising instructions to:
assign resource units (RUs) for a plurality of client devices respectively;
monitoring, by the processor, signal quality between the network device and each of the plurality of client devices; and
determining, by the processor, transmit power of each RU based on the monitored signal quality between the network device and the client device that the RU corresponds to.

18. The non-transitory machine-readable storage medium of claim 17, wherein the non-transitory machine-readable storage medium further comprising instructions to:
determining the transmit power of each RU, based on a first monitored signal quality index between the network device and the corresponding client device;
checking a second monitored signal quality index; and
adjusting the determined transmit power of the RU, in response to the second monitored signal quality index deviating from a preconfigured condition.

19. The non-transitory machine-readable storage medium of claim 18, wherein the first monitored signal quality index includes at least one of receive signal strength indicator (RSSI) and a distance between the network device and the client device.

20. The non-transitory machine-readable storage medium of claim 18, wherein the second monitored signal quality index includes at least one of packet error rate and data rate between the network device and the client device.
